(19) United States
(12) Patent Application Publication
(10) Pub. No.: US 2012/0005914 A1
(43) Pub. Date: Jan. 12, 2012

(54) RINSE CONTAINER, DEVICE FOR RINSING A COMPONENT OF A LAUNDRY DRYING MACHINE, AND LAUNDRY DRYING MACHINE

(75) Inventors: Frank Kohlrusch, Berlin (DE); Günter Steffens, Dallgow-Doberitz (DE)

(73) Assignee: BSH BOSCH UND SIEMENS HAUSGERÄTE GmbH, Munich (DE)

(21) Appl. No.: 13/256,474

(22) PCT Filed: Mar. 15, 2010
(86) PCT No.: PCT/EP2010/053258

§ 371 Date: Sep. 14, 2011

(30) Foreign Application Priority Data
Apr. 1, 2009 (DE) 10 2009 002 076.4

(51) Int. Cl. F26B 19/00

(52) U.S. Cl. 34/90

(57) ABSTRACT

A rinsing device for rinsing at least one component to be cleaned of a laundry drying machine by means of a rinsing fluid includes a rinse container having an outlet opening for draining the rinsing fluid to the component. A sealing part selectively opens and closes the outlet opening, with the sealing part having a sealing head for sealing the outlet opening. A spring element connects the sealing head to the rinse container and urges the sealing head against the outlet opening. The sealing part of the rinse container is activated by an activation unit.

The invention relates to a device for rinsing at least one component to be cleaned of a laundry drying machine by means of a rinsing fluid, comprising a rinse container for storing the rinsing fluid, the rinse container having an outlet opening for draining the rinsing fluid to the component to be cleaned and a sealing part for selectively opening and closing the outlet opening; and an activation unit for activating the sealing part. The invention further relates to a laundry drying machine comprising such a device.

A method and a device for removing lint from a condensed water separator configured as a heat exchanger are known (DE 37 38 031 C2). In this case, a relatively small quantity of approximately half a liter of condensed water is used for one-off rinsing of the plates of the condenser device provided. The relevant rinsing process lasts in this case approximately 30 seconds. A relatively thorough rinsing of the condenser device is required in order to remove lint effectively from the condenser device, however, said lint having remained suspended during the drying of damp laundry. This necessitates the use of a relatively powerful pump which pumps the condensed water out of the condensed water tank to the rinsing device which is present. However, it is desirable to avoid such a high outlay and to manage with a more simple arrangement, in order to clean a component arranged within a process air circuit of a washer-dryer or laundry drying machine, in particular an evaporator of a condenser device, by means of the condensed water.

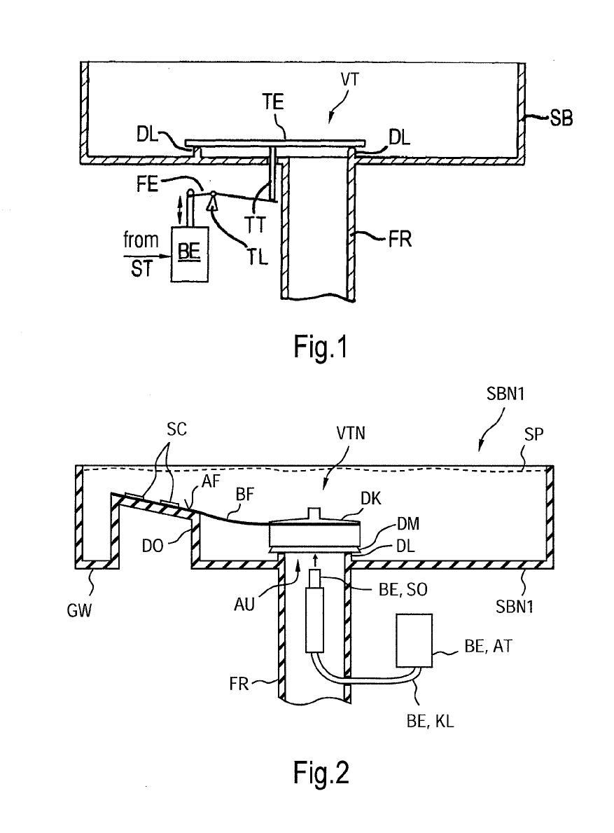

WO 2008/119611 A1 discloses a method and a device for cleaning a component, in particular an evaporator of a condenser device, as well as a washer-dryer or laundry drying machine comprising such as device. For cleaning a component arranged within a process air circuit of a washer-dryer or laundry drying machine, in particular an evaporator of a condenser device, condensed water which is obtained in the process air circuit from drying damp laundry and is collected in a condensed water tank is conveyed to a rinse container provided above the evaporator and by the abrupt opening thereof on the outlet side is discharged as a surge of water to the relevant component. The rinse container from WO 2008/119611 A1 is described in more detail below in FIG. 1 and covers an outlet opening for rinsing water by means of a sealing plate. The sealing plate is passed through the rinse container and is connected to an activation unit by an external part. In this case, the sealing plate may easily lift away from the outlet opening, for example as a result of turbulence during the entry of the rinsing fluid. In particular with a low filling state of the rinsing fluid in the rinse container, no fluid pressure or only a small amount of fluid pressure acts on the sealing plate in the closing direction. Possible gaps between the sealing plate and the outlet opening may not be completely closed where the fluid pressure is too low and thus may lead to leakages. Additionally, the passing-through of the sealing plate may increase the risk of leakages, in particular with operation over a lengthy period.

The object of the invention is to provide a possibility for rinsing at least one component to be cleaned of a laundry drying machine by means of a rinsing fluid, which provides a reliable seal and yet may be implemented easily and cost-effectively.

The object is achieved according to the features of the respective independent claims. Advantageous embodiments are able to be derived, in particular, from the dependent claims.

The rinse container for a laundry drying machine serves for storing a rinsing fluid, the rinse container having an outlet opening for draining the rinsing fluid and a sealing part for selectively opening and closing the outlet opening, the sealing part having a sealing head for sealing the outlet opening, which is connected to the rinse container via a spring element and pressure is exerted by the spring element on the outlet opening.

In this rinse container the outlet opening may be particularly reliably sealed as, for lifting the sealing head and thus for opening the outlet opening, an opening force which is required irrespective of a filling state in the rinse container has to be applied which in terms of magnitude exceeds the pressing force applied by the spring element onto the sealing head. As a result, an inadvertent opening of the outlet opening, for example when introducing the rinsing fluid into the rinse container, may be avoided. Also, a closure is able to be implemented with only a few, simple elements, which permits cost-effective assembly. Also, a through-opening does not need to be provided in the bottom of the rinse container as is required, for example, when using a poppet valve passed through the bottom, which improves the protection against leakages. A further possible leakage due to an inaccurate fit of the sealing head on the outlet opening may also be reduced or even avoided by the pressing force.

Advantageously, the spring element may be a leaf spring, as said leaf spring permits a particularly planar design and is able to be attached easily.

The spring element may be fastened to a dome-like bulged portion of the rinse container, in particular on the bottom side, for simple and accurate fastening. In this case, it may be advantageous, in particular, when a bearing surface of the spring element is located above the outlet opening and is inclined toward the outlet opening; as a result, in a particularly simple manner the spring element may be tensioned at the same time as bearing flat against the outlet opening. A greater pressing force may, for example, be achieved with a leaf spring as a spring element, by a greater inclination of the bearing surface.

A particularly simple fastening of the spring element to the rinse container may advantageously be achieved by the spring element being latched, welded, hot-embossed and/or screwed to the rinse container, in particular the domed portion.

A simple fastening of the sealing head to the spring element may be achieved, in particular, by the sealing head being screwed to the spring element, fastened therein, molded with the spring element or injection-molded around the spring element. The sealing head may be constructed in one piece or in multiple pieces.

A sealing part which is particularly fail-safe and easy to install may be obtained by the sealing head being configured integrally with the spring element. The sealing head may, for example, constitute only an insignificant or inflexible material thickening of the leaf spring, which is located, for example, at one end of the leaf spring.

The material may advantageously comprise a stainless steel, alternatively or additionally a plastics material.

The sealing head may further be provided with at least one sealing element such as an at least partially peripheral sealing collar, for example made of rubber.

The rinsing device serves for rinsing at least one component to be cleaned of a laundry drying machine by means of a rinsing fluid and has such a rinse container and an activation unit for activating the sealing part of the rinse container.

A particularly operationally reliable activation may be achieved by the activation unit activating the sealing head. In other words, the activation element directly acts on the sealing head for activation. Thus, in particular when the rinse container may not be removed, a stroke of an activation element may be transmitted to the sealing head immediately and without stroke loss.

In one embodiment, the activation unit may activate the sealing head through the outlet opening. Thus passing through a wall of the rinse container, which potentially risks leakage, may be eliminated.

Alternatively, the activation unit, for example, may directly activate the leaf spring. To this end, the activation unit may be accommodated, in particular, in the rinse container or extend through a wall of the rinse container.

The activation unit may have an actuator part and a tappet which may be moved by the actuator part. The actuator part may, in particular, convert an electrical signal into a corresponding mechanical stroke movement, which is transmitted by the tappet to the sealing part for the activation thereof. By a use of a tappet, a simple and low maintenance force transmission is possible.

The tappet may be arranged directly on the actuator part or be connected therewith via at least one force introduction element, in particular a flexible force introduction element. By the use of a force introduction element, a positioning of the actuator part may advantageously be undertaken which is substantially irrespective of a positioning of the tappet in the vicinity of the sealing part.

In particular, the outlet opening may open toward a downpipe, the actuator part being arranged outside the rinse container and outside the downpipe, and the tappet being arranged in the downpipe. As a result, the actuator part does not need to be expensively protected against moisture, while the less sensitive tappet is able to come into direct contact with and strike the sealing head. In this case, a stroke movement of the actuator part may be transmitted by a force introduction element and also by the tappet onto the sealing part and/or the sealing head.

For maintaining a sufficient opening force it may be preferable if a stroke path of the activation unit which may be transmitted to the sealing part is a maximum of 30 mm, in particular a maximum of 25 mm. The activation unit may be provided with a stroke booster, for example with a mechanical stroke transmitter which performs a boosting function.

For generating a powerful abrupt surge of water, it may be preferable if a stroke path of the actuator part required for completely opening the sealing part is covered in less than 2 s, in particular in less than 0.5 s, specifically in less than 0.2 s.

Preferably, the activation device is a rapid switching activation device in order to open the outlet opening rapidly, in order to be able to discharge the surge of rinsing fluid to the component to be cleaned in a particularly surge-like manner, and namely in particular to an evaporator of a condenser device or to a lint filter. Particularly preferably, the activation device has a solenoid actuator as the solenoid actuator is able to switch rapidly and is compact and cost-effective. However, the invention is not limited thereto; thus also a piezoelectric actuator, a magnetostrictive actuator, a rapidly moving servo motor etc. may be used. If, for example, a rinsing fluid quantity of 2.5 liters is assumed, which is collected in the rinse container, an efficient cleaning of the component to be cleaned is achieved by this rinsing fluid quantity being discharged in a surge-like manner within a timespan of approximately 1 s to 2 s. In the case of the discharge of 2.5 liters of rinsing fluid within 1 s, this corresponds to a discharge quantity of 150 liters/min of rinsing fluid.

In the case of discharging rinsing fluid within 2 s which is taken as an example, this corresponds to a discharge of rinsing fluid of 75 liters/min. For example, with condensed water as rinsing fluid, such water quantities—should it be desired to use a pump for the discharge thereof—could only be discharged with a relatively large-volume and powerful feed pump, the use thereof in washer-dryers or laundry drying machines not being able to be considered for conveying condensed water for cleaning components arranged within process air circuits, and namely in particular evaporators of condenser devices.

The rinsing fluid may consist at least partially of fresh water. However, it is preferable for low water consumption if the rinsing fluid at least partially contains condensed water. This condensed water is preferably able to be removed from a condensed water tank, the condensed water tank being designed and arranged to collect condensed water produced in a process air circuit by drying damp washing. Expediently, the condensed water is pumped by means of a pump from the condensed water tank into the rinse container of the aforementioned collection container. This constitutes a relatively simple possibility for the provision of the condensed water which is discharged as surge water for cleaning the component formed, in particular, by an evaporator of a condenser device. In this case, advantageously a relatively small, low-powered pump may be sufficient to pump the condensed water from the condensed water tank into the rinse container. The power of such a pump, in particular in terms of order of magnitude, is well below the power of a pump as has been mentioned in the introduction in connection with the principal embodiment of the present invention.

The object is also achieved by means of a laundry drying machine which comprises the above-mentioned device for rinsing.

The laundry drying machine is preferably provided with a component to be cleaned arranged within a process air circuit of a washer-dryer or tumble dryer, in particular an evaporator of a condenser device and/or a lint filter, and with a condensed water tank into which condensed water produced in the process air circuit by drying damp laundry may be collected, may be conveyed out of said condensed water tank to the rinse container provided above the evaporator as described above, and may be discharged therefrom out of an outlet opening to the component to be cleaned.

The laundry drying machine may preferably be designed as a washer-dryer or a tumble dryer. It should be noted here that a “washer-dryer” is understood as a combination device which has a washing function for washing laundry and a drying function for drying damp laundry. A tumble dryer, in contrast, has only one drying function for drying damp laundry.

The component to be cleaned may, for example, be an evaporator of a condenser device. Additionally or alternatively, the component to be cleaned may be a lint filter, for example a lint filter for cleaning lint from a process air flow.

The rinse container may be arranged fixedly (not removably) in the laundry drying machine. Alternatively, the rinse container may be removable from the laundry drying machine; then it may be particularly advantageous if the activation unit is attached in a fixed manner. In the event of a removable rinse container, the rinse container may be removed from the dryer and handled by a user, due to the presence of the spring element, without a risk of inadvertent opening of the outlet opening.

The laundry drying machine is preferably characterized in that the rinse container on its outlet side has the sealing part, and by the abrupt opening thereof the rinse container is able to discharge the rinsing fluid contained therein, in particular condensed water, in a surge-like manner through a downpipe to the aforementioned component, and in that alternatively or additionally to discharging the condensed water from the rinse container a supply pipe supplying pressurized mains water on the outlet side permits the relevant mains water to be discharged to the aforementioned component. This provides the advantage of a particularly low outlay for the device for a particularly efficient cleaning of a component arranged within a process air circuit of a washer-dryer or tumble dryer.

Expediently, the aforementioned downpipe has a region which is narrowed relative to the cross section of the outlet region of the rinse container and/or the rinsing chamber. As a result, in a relatively simple manner the discharge of the surge of water may be equalized between the start and finish thereof.

According to a further expedient embodiment of the laundry drying machine, where an evaporator forms the aforementioned component of a condenser device, the water surge and/or the pressurized mains water may be discharged to an evaporator region only at a fixed distance from the inlet region of the process air in the evaporator by means of a fixedly arranged rinsing nozzle connected to the downpipe. This provides the advantage of particularly effective cleaning of the main region of the evaporator to be cleaned, into which the process air enters and primarily deposits contaminants there, such as lint.

According to a further expedient development of the present laundry drying machine, the rinsing nozzle and/or the downpipe are able to be deflected during the discharge of the water surge and/or the pressurized mains water by a deflection device actuated mechanically, hydraulically, pneumatically or electromechanically from an initial region located at the inlet region of the process air in the evaporator of the condenser device to an end region located at a distance therefrom in the direction of the outlet region of the process air from the evaporator. This provides the advantage that the evaporator of the condenser device may be cleaned by the aforementioned water surge over a fixed length which, in particular, may be its entire length, over which it is passed through by the process air.

In the following figures, the invention is described schematically in more detail with reference to an exemplary embodiment. In this case, elements which are the same or function in the same way in different exemplary embodiments may be provided with the same reference numerals.

In the drawings:

FIG. 1 shows as a sectional view and in side view a rinse container according to the prior art,

FIG. 2 shows as a sectional view and in side view a rinse container according to a first embodiment,

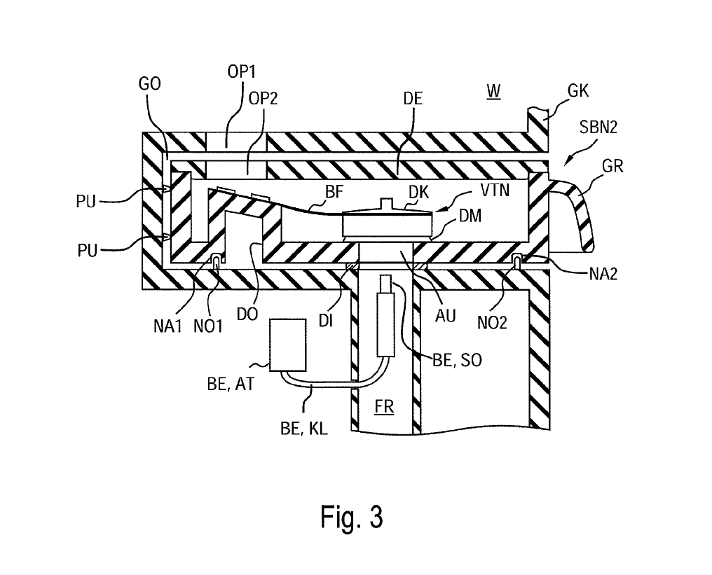

FIG. 3 shows as a sectional view and in side view a rinse container according to a second embodiment in a first position,

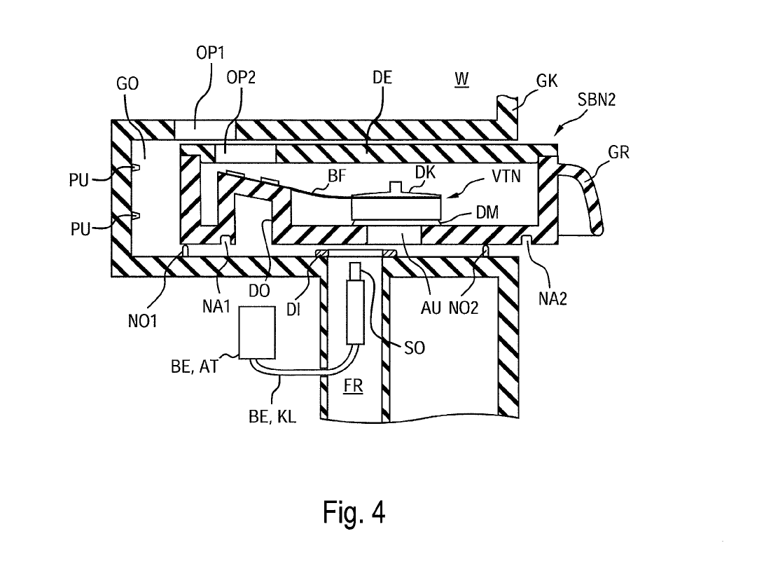

FIG. 4 shows as a sectional view and in side view a rinse container according to a second embodiment in a second position,

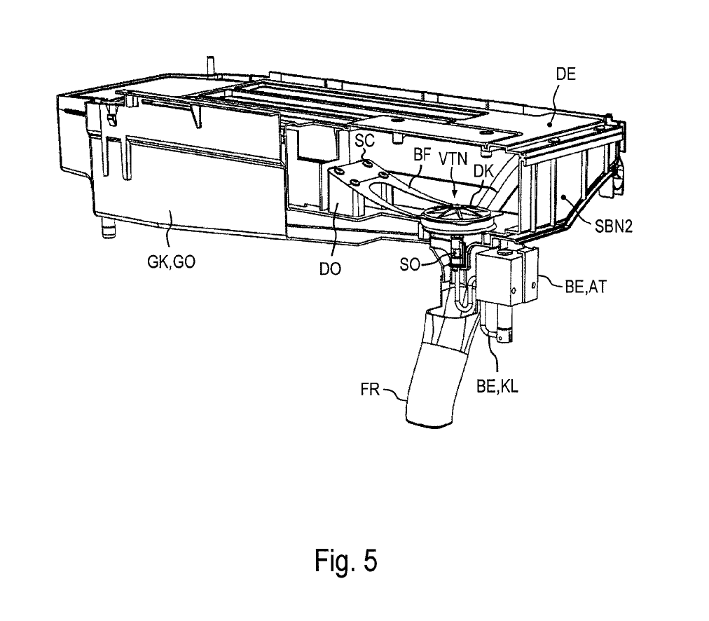

FIG. 5 shows in an oblique view a partial section of the rinse container shown in FIG. 3 and FIG. 4, as used in one possible guide device.

FIG. 1 shows a schematically indicated rinse container SB according to the prior art, according to FIG. 2, from WO 2008/119611 for use in a laundry drying machine. A sealing part VT of the rinse container SB is formed by the rinse container SB comprising sealing regions and/or sealing lips DL in the region of a downpipe FR connected thereto, and on which in the closed state of the sealing part VT a sealing plate TE sealingly bears with its lower face. Said sealing plate TE has in a central region on its underside a support part TT, which extends sealingly through a bottom part of the rinse container SB and with its lower end bears against an end region of a relatively long pivoting part of a bistable spring FE. This bistable spring FE formed, for example, by a leaf spring which may be provided with a spring function, is carried at its mounting point by a fixedly arranged carrier part TL, about which the relevant bistable spring FE may snap, upon the activation thereof. At the end of its relatively short pivoting region from the carrier part TL the bistable spring FE is connected to a tappet of an activation device BE. This activation device BE may be an activation device operating thermally or electromechanically, such as a thermal-relay or a magnetic relay, which may be activated by control device ST. By means of the ratio between the pivoting ranges of the bistable spring FE provided on both sides of the carrier part TL, a relatively short stroke of the tappet of the activation device BE may trigger a substantially greater stroke of the sealing plate TE relative thereto (lever principle), in particular due to the bistable spring function of the spring FE, so that the condensed water contained in the rinse container SB may be discharged as a water surge through the downpipe FR. The water surge is used to rid an evaporator of a condenser device of a washer-dryer or tumble dryer from contaminants adhering thereto, in particular lint, as disclosed, for example, in WO 2008/119611.

FIG. 2 shows a rinse container SBN1 which may be used instead of the rinse container SB disclosed in WO 2008/119611. For sealing an outlet opening AU which opens toward the downpipe FR, the rinse container SBN1 has a sealing part VTN with a sealing head DK. The sealing head DK has on its underside a sealing collar DM and sealingly bears with the sealing collar DM against a sealing lip DL of the rinse container SBN1 in the closed state shown of the sealing part VTN. The sealing head DK is fastened to one end of a leaf spring BF. The other side of the leaf spring BF is fastened to a planar bearing surface AF of a domed portion and/or a dome-like bulged portion DO of the rinse container SBN1 via screws SC. The dome-like bulged portion DO is in this case configured as a bulge on the bottom side of a housing wall GW of the rinse container SBN1. In order to press the sealing head DK in the closed state with a sufficient pressing force onto the sealing lip DL, the bearing surface AF is inclined in the direction of the outlet opening AU, so that the leaf spring BF is pretensioned when bearing against the sealing lip DL. At the same time, the bearing surface AF is positioned so that the sealing head DK sits flat on the sealing lip DL. The sealing head DK is preferably produced from plastics material, for example by means of an injection-molding process, and screwed to the leaf spring BF. Alternatively, the sealing head DK may also be connected, molded etc. to the leaf spring BF. In a further embodiment, the sealing head may be designed in one piece with the leaf spring, for example from a metal.

For opening the sealing part VTN from its closed position, the sealing head DK is pushed up from below and thus lifted away from the sealing lip DL, as is now described in more detail. For opening the sealing part VTN, an activation device BE with an actuator part AT and a tappet SO is provided, the tappet SO being connected to the actuator part AT via a flexible force introduction element KL, which forwards a stroke of the actuator part AT to the tappet. The actuator part AT is arranged outside the rinse container SBN1 and when activated permits a tappet SO to be extended.

The tappet SO is positioned inside the downpipe FR below the sealing head DK, so that in a retracted state (no activation of the actuator part AT), as shown, is spaced apart from the sealing head DK. In a fully extended state (with the activation of the actuator part AT) the tappet SO bears against the underside of the sealing head DK and lifts said sealing head away from the sealing lip DL by a predetermined stroke path. By opening the sealing part VTN, the rinsing fluid stored in the rinse container SBN1, in the form of condensed water SP, may be discharged as a water surge through the downpipe FR.

The use of a solenoid actuator is appropriate, in particular, for the actuator part AT. Thus it may be connected to a mains voltage of, for example, 110 or 230 VAC and thus does not require a separate power supply. Additionally, by using a simple rectifier, for example a bridge rectifier, the solenoid actuator may also be used in a DC configuration which provides the possibility of noise damping, which is not possible with a purely AC solenoid actuator. Impact noise between the pole core and the armature may then be markedly reduced in the solenoid actuator operated by DC current, for example by insulating plates between the armature and pole core. Moreover, a solenoid actuator has a rapid opening time (typically approximately 100-400 ms) which is advantageous as the rinsing action/water surge is based to a large extent on the high kinetic energy of the water which is in the rinse container SBN1. This energy may, however, only be effectively utilized when the sealing head DK lifts up sufficiently rapidly. The solenoid actuator as such is additionally substantially more cost-effective relative to servo motors.

In addition to the rapidity of the activation device BE, however, the opening cross section to the downpipe FR also plays an important role, i.e. the sealing head DK not only has to open rapidly enough but also has to open to a sufficient extent. In this case, due to the small constructional space available, a solenoid actuator has a certain drawback as the force-path characteristic curve becomes increasingly disadvantageous with stroke paths of more than 15 mm. In other words, the opening path and the opening force on the sealing head DK have to be adapted to one another. The opening force (the force which is required for lifting up the sealing head) includes, among other things, the spring force of the leaf spring BF, the static water column above the sealing head DK and kinetic and static friction forces.

FIG. 3 and FIG. 4 show a rinse container SBN2 according to a second embodiment. The rinse container SBN2 differs substantially from the rinse container SBN1 shown in FIG. 2, in that the rinse container SBN2 is a manually removable rinse container SBN2, through which condensed water may also be disposed of to the outside. In addition to the rinse container SBN1 shown in FIG. 2, the rinse container SBN2 on its upper face is covered by a lid DE. On its end shown to the right in FIG. 3 and FIG. 4, the rinse container SBN2 has a grip GR with which the rinse container SBN2 is able to be inserted into a corresponding receiver opening GO of a device body GK of a laundry drying machine W which serves as a guide device for the rinse container SBN2. FIG. 3 shows the rinse container SBN2 in a state in which said rinse container is inserted fully into the receiver opening GO of the device body GK, and FIG. 4 shows the case where the rinse container SBN2 has been slightly withdrawn from this receiver opening GO of the device body GK.

In the state inserted into the aforementioned receiver opening GO shown in FIG. 3, the rinse container SBN2 with its end region shown to the left bears against buffers PU which are adjacent to the inside of the receiver opening GO receiving the rinse container SBN2. In this state, the rinse container SBN2 comprising cam receivers NA1 and NA2 provided in its underside is received by cams NO1 and/or NO2 which protrude from the underside of the relevant receiver opening GO. In this state, the rinse container SBN2 is lowered relative to the underside of the aforementioned receiver opening GO of the device body GK and thus bears sealingly by means of a sealing member in the form of a sealing ring DI against the underside of the aforementioned receiver opening GO. As a result, damp process air, which may rise in the downpipe FR, is able to reach neither the rinse container SBN2 nor the outside of the device body GK. In this state, the outlet opening AU in the lower region of the rinse container SBN2 is also sealed, and namely by the sealing part VTN, similar to the embodiment according to FIG. 2. In the embodiment shown, the sealing head DK bears directly against the outlet opening AU which is not surrounded by a sealing lip DL. A secure seat is achieved in this case by the substantially plane-parallel position and/or flat position of the sealing head DK on the bottom of the rinse container SBN2 and a seal of the sealing collar DM. Alternatively, however, the outlet opening AU could also be surrounded by a sealing lip, among other things.

When withdrawing the rinse container SBN2 from the aforementioned receiver opening GO by means of the grip GR, the underside of the rinse container SBN2 slides on the cams NO1 and NO2 and thereby prevents damage or wear of the sealing ring DI as visible in FIG. 4.

In the position shown in FIG. 3 of the rinse container SBN2, two through-openings OP1 and OP2 for filling up with condensate are aligned with one another, of which the through-opening OP1 is provided in the rear region of the aforementioned receiver opening GO of the device body GK and of which the through-opening OP2 is provided in the corresponding region of the lid DE of the rinse container SBN2.

FIG. 5 shows a part of the rinse container SBN2 with a visible detail of the sealing part VTN, the rinse container SBN2 being inserted into the receiver opening GO of the device body GK. The activation device BE is arranged on an outer face of the part of the device body GK forming the guide unit GO, the tappet SO thereof being arranged for contact with the underside of the sealing head DK in the downpipe FR.

The invention is not limited to the embodiments shown.

Thus, for example, a piezoelectric actuator with a stroke boosting function or a rapid servo motor may also be used instead of a solenoid actuator. Also, the rinse container may be subdivided into two chambers, namely a rinsing chamber and a collection chamber, which is subdivided by a partition or intermediate wall. The condensed water pumped up by the pump from the condensed water tank may, for example, initially reach the rinsing chamber through the connection channel. As the partition may be configured to be slightly lower in height than the height of the edge regions of the rinse container which constitutes a combination container or, in abbreviated form, combi-container, initially the rinsing chamber is filled with condensed water from the condensed water tank. If the rinsing chamber is filled with condensed water, further condensed water supplied thereto reaches the collection chamber by overflowing therein. If the collection chamber is full, water may be discharged out of said collection chamber via an overflow.

### List of Reference Numerals

AF Bearing surface
AU Outlet opening
BE Activation device
DE Lid
DI Sealing member and/or ring
DK Sealing head
DL Sealing regions and/or lips
DM Sealing collar
DO Dome-like bulged portion
FE Bistable spring
FR Downpipe
GO Receiver opening
GR Grip
GW Housing wall
KL Force introduction element
NA1, NA2 Cam receiver
NO1, NO2 Cam
OP1, OP2 Opening
PU Buffer
SB Rinse container according to prior art
SBN1, SBN2 Rinse container according to the invention
SC Screw
SO Tappet
SP Rinsing fluid
ST Control device
TE Sealing plate
TL Support part
TT Carrier part
VT Sealing part according to prior art
VTN Sealing part according to the invention
W Laundry drying machine

1-15. (canceled)

16. A rinse container for a laundry drying machine for storing a rinsing fluid, said rinse container comprising:
an outlet opening for draining the rinsing fluid;
a sealing part for selectively opening and closing the outlet opening, said sealing part having a sealing head for sealing the outlet opening; and
a spring element connecting the sealing head to the rinse container and urging the sealing head against the outlet opening.

17. The rinse container of claim 16, wherein the spring element is a leaf spring.

18. The rinse container of claim 16, wherein the spring element is fastened to a dome-like bulged portion of the rinse container.

19. The rinse container of claim 16, wherein the spring element is connected to the rinse container by at least one process selected from the group consisting of latching, screwing, welding and hot-embossing.

20. The rinse container of claim 16, wherein the sealing head has at least one part which is connected or injection-molded onto the spring element.

21. The rinse container of claim 16, wherein the sealing head is configured integrally with the spring element.

22. A rinsing device for rinsing at least one component to be cleaned of a laundry drying machine by means of a rinsing fluid, said rinsing device comprising:
a rinse container having an outlet opening for draining the rinsing fluid, a sealing part for selectively opening and closing the outlet opening, with the sealing part having a sealing head for sealing the outlet opening, and a spring element connecting the sealing head to the rinse container and urging the sealing head against the outlet opening; and
an activation unit for activating the sealing part of the rinse container.

23. The rinsing device of claim 22, wherein the activation unit is constructed to activate the sealing head.

24. The rinsing device of claim 22, wherein the activation unit is constructed to activate the sealing head through the outlet opening.

25. The rinsing device of claim 22, wherein the activation unit is constructed to activate the leaf spring.

26. The rinsing device of claim 22, wherein the outlet opening opens toward a downpipe, said activation unit comprising an actuator part arranged outside the rinse container and outside the downpipe, and a tappet arranged in the downpipe.

27. The rinsing device of claim 22, wherein the spring element is a leaf spring.

28. The rinsing device of claim 22, wherein the spring element is fastened to a dome-like bulged portion of the rinse container.

29. The rinsing device of claim 22, wherein the spring element is connected to the rinse container by at least one process selected from the group consisting of latching, screwing, welding and hot-embossing.

30. The rinsing device of claim 22, wherein the sealing head has at least one part which is connected or injection-molded onto the spring element.

31. The rinsing device of claim 22, wherein the sealing head is configured integrally with the spring element.

32. A laundry drying machine, comprising a rinsing device for rinsing at least one component to be cleaned of the laundry drying machine by means of a rinsing fluid, said rinsing device comprising a rinse container having an outlet opening for draining the rinsing fluid, a sealing part for selectively opening and closing the outlet opening, with the sealing part having a sealing head for sealing the outlet opening, and a spring element connecting the sealing head to the rinse container and urging the sealing head against the outlet opening, and an activation unit for activating the sealing part of the rinse container.

33. The laundry drying machine of claim 32, constructed in the form of a washer-dryer or tumble dryer.

34. The laundry drying machine of claim 32, wherein the activation unit is constructed to activate the sealing head.

35. The laundry drying machine of claim 32, wherein the activation unit is constructed to activate the sealing head through the outlet opening.

36. The laundry drying machine of claim 32, wherein the activation unit is constructed to activate the leaf spring.

37. The laundry drying machine of claim 32, wherein the outlet opening opens toward a downpipe, said activation unit comprising an actuator part arranged outside the rinse container and outside the downpipe, and a tappet arranged in the downpipe.

38. The laundry drying machine of claim 32, wherein the component to be cleaned is an evaporator of a condenser device.

39. The laundry drying machine of claim 32, wherein the component to be cleaned is a lint filter.

40. The laundry drying machine of claim 32, wherein the rinsing fluid at least partially contains condensed water.
